(19) United States
(12) Patent Application Publication
(10) Pub. No.: US 2004/0203624 A1
(43) Pub. Date: Oct. 14, 2004

(54) Technique for sharing of files with minimal increase of storage space usage

(76) Inventor: Jin Teik Teh, Los Altos, CA (US)

Correspondence Address: Jason Z. Lin, Supreme Patent Services, Post Office Box 2339, Saratoga, CA, 95070-0339, US

(21) Appl. No.: 10/357,663

(22) Filed: Feb. 3, 2003

Related U.S. Application Data
(60) Provisional application No. 60/410,583, filed on Sep. 12, 2002.

(51) Int. Cl. H04M 11/10; H04B 1/68

(52) U.S. Cl. 455/412.1; 455/352; 455/203

(57) ABSTRACT

A data delivery system uses a database containing a plurality of contents that can be delivered to the client devices at the requests of a client. Conventionally, data is “owned” by a user, that is, users have their own copies for the data. Such a method requires a large amount of, yet unnecessary, storage space. It is especially true when different users own the same data. A conventional technique, called reference counting, is used in programming where one memory data structure can be shared by multiple processes or other client data structures. Reference counting systems perform automatic memory management by keeping a count in each memory object of how many references there are to the object. Objects to which there are no references may be reclaimed. The reference count is incremented for each new reference, and is decremented if a reference is overwritten, or if the referring object is recycled. If a reference count falls to zero, then the object is no longer required and can be recycled. The invention extends this method to include non-memory resident data as well as data that does not physically reside on the same storage hardware as the clients of these references. The data and references of these data can be on the same server or they can reside around the world.

### FIELD OF THE INVENTION

This invention relates to file management, and more particularly to file sharing techniques on data servers to save storage space in a wireless data delivery system.

### BACKGROUND OF THE INVENTION

FIG. 1 shows a wireless data delivery software system that the present invention is applicable. The system 101 comprises a platform client 102, and a platform server 103. The platform client 102 is responsible for interfacing with various clients, such as a mobile phone 110, a PDA 111, or a notebook computer 112; and the platform server 103 provides interface to various application servers 121. When a wireless client 110, 111, 112 requests for a service from an application, a request message is sent from the client to application server 121. The platform client 102, upon receiving the request message, will relay the request to the platform server 103, then forwarded to targeted application server 121, where the request is processed, and a result message is sent back to the requesting client 110, 111, 112.

The aforementioned system includes a database containing a plurality of content such as e-Books, e-Comics, news, stock quotes, phone books, horoscope or any electronic document that can be delivered to the client devices at the requests of a client. Conventionally, data is “owned” by a user, that is, users have their own copies for the data. Such a method requires a large amount of, yet unnecessary, storage space. It is especially true when different users own the same data, for example, a user may have downloaded a music file and stored it online on a data server, while another user performed the same task.

A conventional technique, called reference counting, is used in programming where one memory data structure can be shared by multiple processes or other client data structures. Reference counting systems perform automatic memory management by keeping a count in each memory object, usually in a header, of how many references there are to the object. Objects to which there are no references may be reclaimed. The reference count is incremented for each new reference, and is decremented if a reference is overwritten, or if the referring object is recycled. If a reference count falls to zero, then the object is no longer required and can be recycled.

The invention extends this method to include non-memory resident data as well as data that does not physically reside on the same storage hardware as the clients of these references. The data and references of these data can be on the same server or they can reside around the world.

### SUMMARY OF THE INVENTION

The present invention describes a method for allowing users to store their own copy of files and data but without significantly increasing the amount of storage space required. By using a technique similar to the memory reference counting, the invention allows data sharing among users with a minimal increase of memory requirement, which is usually less than 1K bytes, depending on data type. Using the present invention, data hosting can support virtually unlimited number of users without significantly increasing the hardware and storage space required. Furthermore, the present invention also allows the shared data or files to reside on different computers across the internet.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a wireless data delivery software system.

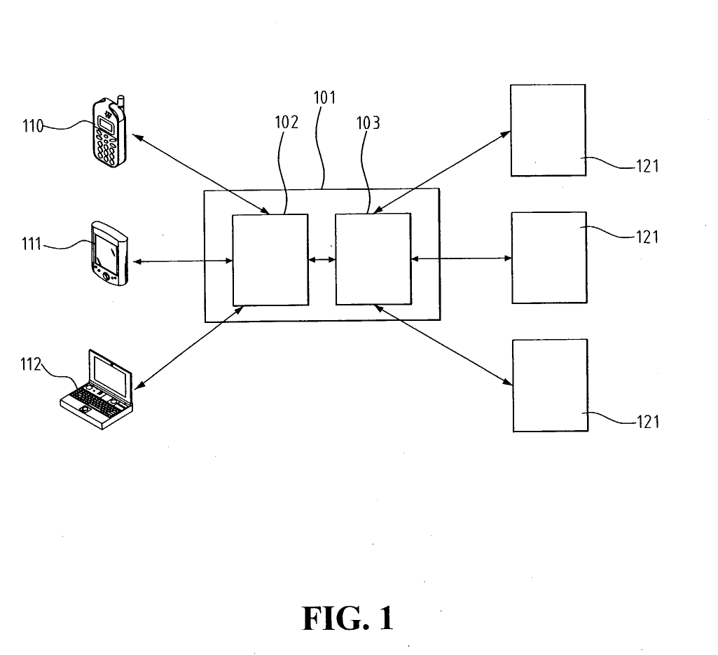

FIG. 2 shows the structure of a meta information record of a file.

### DETAILED DESCRIPTION OF THE INVENTION

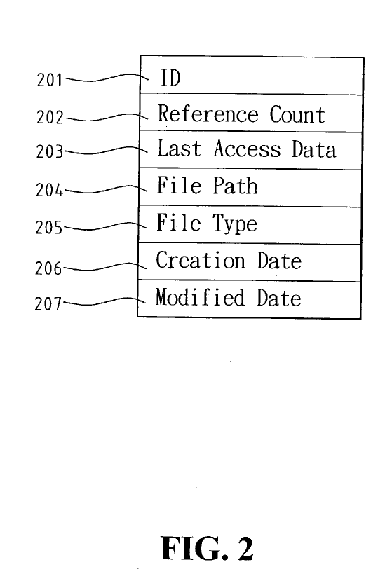

FIG. 2 shows the data structure of a meta information record of a file or data. This meta information record is a record that contains information about the corresponding file or data. A meta information record for a file or data is created when this file or data is first created or referenced. Subsequent references to this file or data will only update the corresponding meta information record. The ID field 201 contains a unique identification number of the file or data. The Reference Count filed 202 contains the number of the times this file or data is referenced. When a client references the file, e.g., when a user retrieves or purchase the file or data, the count is incremented. It is decremented when a user deletes their copy. The field Last Access Date 203 shows the date when the file or data was last accessed. The File Path 204 and File Type 205 contain the path to the file, and the type of the file, respectively. Finally, the Creation Date field 206 and Modified Date field 206 contain the dates when the file or data was created, and last modified.

There is a owner for every file or data in the system. If a file or data is non-editable, the system is assigned as the owner. Otherwise, the creator of the file or data is the owner of that file or data. The owner of the file or data has the privilege to modify the file or data, and the changes will be reflected to all the users or clients sharing the file or data. For example, a company's address book may be shared by all the company staff. The address book may only be modified by the human resource department, yet the changes will be reflected to all the company staff.

The additional meta information record takes up limited storage space, while saving the system from keeping multiple copies of the same file. For editable files or data, additional information on the user privilege will be required. In most cases, this meta information record could be kept no more than a few hundred of bytes.

Conventional file sharing techniques, such as symbolic link, allow only the sharing of files on a common network, or within a single domain name space. Compared to the conventional techniques, the present invention allows the shared files or data to reside on different computers across the internet.

While we have shown and described the embodiment in accordance with the present invention, it should be clear to those skilled in the art that further embodiments may be made without departing from the scope of the present invention.

What is claimed is:

1. In a wireless data delivery system having a plurality of application clients and a plurality of application servers, a method of data and file sharing techniques on data servers having a plurality of contents to save storage space, comprising:
creating a record for a file or data when said file or data being created;
updating said record when said data or file being referenced or a reference being terminated.

2. A method claimed as in claim 1, wherein said record for the file or data is further comprising the following fields:
an ID field, containing a unique identification number of said file or data;
a Reference Count field, indicating the number of times said file or data being referenced;
a Last Access Date field, indicating the date when said file or data being accessed;
a File Path field, showing the path to said file or data;
a File Type field, showing the type of said file or data;
a Creation Date field, showing the date when said file or data being created; and
a Modified Date field, showing the date when said file or data being last modified.

3. A method claimed as in claim 1, wherein said processor increments said Reference Count field when said data or file being referenced.

4. A method claimed as in claim 1, wherein said processor decrements said Reference Count field when a reference to said data or file being terminated.

5. A method claimed as in claim 1, wherein the owner to said file or data being based on the editability of said file or data. For non-editable file or data, said owner being set to be the system, while for editable file or data, said owner being said to be the creator of said file or data.

6. An apparatus connecting to a wireless data delivery system having a plurality of application clients and a plurality of application servers, said apparatus comprising:
a first memory storing a record for every data and file;
a second memory storing a program; and
a processor responsive to the program to
create a record for a file or data when said data or file being created;
update said record when said data or file being referenced or a reference being terminated.

7. An apparatus claimed as in claim 6, wherein said record further comprising:
an ID field, containing a unique identification number of said file or data;
a Reference Count field, indicating the number of times said file or data being referenced;
a Last Access Date field, indicating the date when said file or data being accessed;
a File Path field, showing the path to said file or data;
a File Type field, showing the type of said file or data;
a Creation Date field, showing the date when said file or data being created; and
a Modified Date field, showing the date when said file or data being last modified.

8. An apparatus claimed as in claim 6, wherein said processor increments said Reference Count field when said data or file being referenced.

9. An apparatus claimed as in claim 6, wherein said processor decrements said Reference Count field when a reference to said data or file being terminated.

10. A wireless data delivery system having a plurality of application clients, a plurality of application servers, and a means to share files on a plurality of data servers across internet having a plurality of contents to save storage space.

11. A system claimed as in claim 10, wherein said contents are e-Books.

12. A system claimed as in claim 10, wherein said contents are e-Comics.

13. A system claimed as in claim 10, wherein said contents are news.

14. A system claimed as in claim 10, wherein said contents are stock quotes.

15. A system claimed as in claim 10, wherein said contents are phone books.

16. A system claimed as in claim 10, wherein said contents are horoscope.

17. A system claimed as in claim 10, wherein said contents are other electronic documents.
